(19) United States
(12) Patent Application Publication
(10) Pub. No.: US 2014/0199433 A1
(43) Pub. Date: Jul. 17, 2014

(54) POLYDIORGANOSILOXANE-ENCAPSULATED ACTIVE INGREDIENT, METHOD FOR THE PREPARATION THEREOF, AND CHEWING GUM COMPRISING SAME

(71) Applicant: Intercontinental Great Brands LLC, East Hanover, NJ (US)

(72) Inventors: Navroz Boghani, Budd Lake, NJ (US); Petros Gebreselassie, Whitehouse Station, NJ (US); Kiran Vyakaranam, Morristown, NJ (US)

(73) Assignee: Intercontinental Great Brands LLC, East Hanover, NJ (US)

(21) Appl. No.: 14/128,183

(22) PCT Filed: Jun. 27, 2012
(86) PCT No.: PCT/US2012/044312

§ 371 Date: Feb. 14, 2014

Related U.S. Application Data
(60) Provisional application No. 61/501,397, filed on Jun. 27, 2011.

(51) Int. Cl. A23G 4/06

(52) U.S. Cl. CPC A23G 4/06
USPC 426/6; 426/3

(57) ABSTRACT

Delayed release in chewing gum of an active ingredient, such as a sweetener or a food acid, is provided by encapsulating solid particles of the active ingredient in a polydiorganosiloxane. The resulting polydiorganosiloxane-encapsulated active ingredient includes a continuous phase with the polydiorganosiloxane and a disperse phase with the solid particles of the active ingredient. When incorporated into a chewing gum, the polydiorganosiloxane-encapsulated active ingredient provides a more delayed release than conventional poly(vinyl acetate)-encapsulated active ingredients.

### BACKGROUND OF THE INVENTION

Chewing gum manufacturers have long endeavored to provide longer lasting flavors in chewing gums containing actives such as flavorings, sweeteners, and food acids. During mastication of the chewing gum the actives are generally released simultaneously to provide the flavor experienced by the consumer. However, chewing gum manufacturers have been unable to provide a chewing gum that precisely controls the release of flavorings, sweeteners, and food acids for enhanced flavor-changing gum compositions. For example, flavors and sweeteners have been encapsulated with polymers like poly(vinyl acetate) to delay and prolong their release. See, for example, U.S. Pat. Nos. 4,931,293, 5,057,328, 5,064,658, and 5,110,608 to Cherukuri et al. When applied to highly water-soluble flavors and sweeteners, such as the food grade acids used to impart tartness to chewing gum, this approach yields an inadequately delayed release profile. For example, with current interest in flavor-changing chewing gums it has not heretofore been possible to prepare an acceptable flavor-changing gum that features a sour flavor as the second or subsequent flavor of the gum. There is therefore a need for materials and methods capable of delaying or extending the release of highly water-soluble active ingredients for chewing gum.

### BRIEF DESCRIPTION OF EMBODIMENTS OF THE INVENTION

One embodiment is a chewing gum composition comprising a polydiorganosiloxane-encapsulated active ingredient, wherein the polydiorganosiloxane-encapsulated active ingredient comprises a continuous phase comprising a polydiorganosiloxane, and a disperse phase comprising solid particles comprising an active ingredient.

Another embodiment is a chewing gum composition comprising at least one first flavor composition; and at least one second flavor composition comprising a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient, wherein the at least one first flavor composition begins to release from the chewing gum when the chewing gum composition is masticated, and the at least one second flavor composition begins to release after the at least one first flavor composition has begun to release.

Another embodiment is a chewing gum composition comprising at least one first flavor composition; at least one second flavor composition; and at least one third flavor composition comprising a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient, wherein the at least one first flavor composition begins to release from the chewing gum when the chewing gum composition is masticated, the at least one second flavor composition begins to release after the at least one first flavor composition has begun to release and the at least one third flavor composition releases after the second flavor composition begins to release.

Another embodiment is a material comprising a continuous phase comprising a polydiorganosiloxane; and a disperse phase comprising an active ingredient that is a solid at 25° C. and one atmosphere.

Another embodiment is a method of forming a polydiorganosiloxane-encapsulated active, comprising dispersing solid particles comprising an active ingredient in a curable polydiorganosiloxane composition; and curing the curable polydiorganosiloxane composition to form a polydiorganosiloxane-encapsulated active ingredient comprising a continuous phase comprising a polydiorganosiloxane, and a disperse phase comprising solid particles comprising the active ingredient.

Another embodiment is a method of forming a chewing gum, comprising forming a polydiorganosiloxane-encapsulated active, wherein forming the encapsulated active comprises dispersing solid particles comprising an active ingredient in a curable polydiorganosiloxane composition; curing the curable polydiorganosiloxane composition to form the polydiorganosiloxane-encapsulated active ingredient comprising a continuous phase comprising a polydiorganosiloxane, and a disperse phase comprising solid particles comprising the active ingredient; and processing the polydiorganosiloxane-encapsulated active into a particulate form; and dispersing the particulate form of the polydiorganosiloxane-encapsulated active into a gum base.

These and other embodiments are described in detail below.

### BRIEF DESCRIPTION OF THE DRAWINGS

FIG. 1 is a plot showing the percent of the citric acid released (%) versus time (minutes) for the dissolution profiles of citric acid encapsulations.

### DETAILED DESCRIPTION OF THE INVENTION

The present invention is directed to a material containing a polydiorganosiloxane-encapsulated active ingredient and chewing gum compositions containing the same that can provide the end-user with a sequential taste experience. More specifically, upon mastication the user can experience a flavor change from a sweet flavor to a sour flavor. In additional embodiments the user can experience a flavor change from a sweet flavor to a sour flavor and then back to a sweet flavor. The present invention therefore provides a sequential flavor-changing experience wherein the sour flavor can be sensed as the second or subsequent flavor of the gum. This taste changing property of the gum is achieved by using precisely designed encapsulations with food acids and sweeteners as actives.

According to the present invention it has unexpectedly been found that encapsulating active ingredients in polydiorganosiloxanes can extend or delay the release of the active ingredients. The polydiorganosiloxane-encapsulated active ingredients can further be incorporated into a chewing gum composition in order to more precisely control the flavors experienced by the end-user. Furthermore, food grade acids encapsulated in polydiorganosiloxane can be used to prepare a flavor-changing gum featuring a sour flavor as the second or subsequent flavor of the gum.

One embodiment is a material having a continuous phase containing a polydiorganosiloxane and a disperse phase containing an active ingredient. The material can be a polydiorganosiloxane-encapsulated active ingredient containing a continuous phase having a polydiorganosiloxane and a disperse phase having solid particles containing an active ingredient. The polydiorganosiloxane-encapsulated active ingredient can be further incorporated into a chewing gum.

As used herein, the terms “a material,” or “a material having a continuous phase and a disperse phase,” or “a material having a continuous phase containing a polydiorganosiloxane and a disperse phase containing an active ingredient disperse phase” means a two-phase system in which one phase generally consists of substantially finely-divided particles. The particles can be in the colloidal or the particulate size range, and are typically distributed throughout a bulk substance, the particles being the “disperse phase” or “discontinuous phase” and the bulk substance being the “continuous phase” or “homogenous phase.” The distribution of the particles or “disperse phase” within the “continuous phase” can be uniform or non-uniform, and the “disperse phase” is separate and distinct from the “continuous phase.” In addition, in some embodiments, the bulk substance that comprises the “continuous phase” can be a polydiorganosiloxane and the particles that comprise the “disperse phase” can be an active ingredient.

The disperse phase has solid particles of an active ingredient wherein the active ingredient is a solid at 25° C. and one atmosphere. In some embodiments, the active ingredient has a water solubility of at least about 100 grams per liter at 25° C. and one atmosphere, specifically about 200 to about 1000 grams per liter at 25° C. and one atmosphere, and more specifically about 300 to about 800 grams per liter at 25° C. and one atmosphere. For example, citric acid has a water solubility of about 730 grams per liter at 25° C. and one atmosphere. And malic acid has a water solubility or about 588 grams per liter at 20° C. and one atmosphere. In some embodiments, the disperse phase comprises at least about 50 weight percent of the active ingredient. The disperse phase can comprise at least about 75 weight percent of the active ingredient, specifically at least about 90 weight percent of the active ingredient and more specifically at least about 95 weight percent of the active ingredient, based on the total weight of the disperse phase. In some embodiments, the disperse phase consists of the active ingredient.

The continuous phase is a polydiorganosiloxane-containing polymer material. The polydiorganosiloxane of the continuous phase can have the repeating units of the structure represented by the following formula:

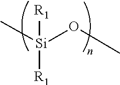

wherein each occurrence of R₁ is independently an unsubstituted or substituted C₁-C₁₂ hydrocarbyl, and wherein n equals the number of repeating units. In some embodiments, n equals from about 700 to about 12,000 repeating units.

As used herein, the term “hydrocarbyl”, whether used by itself, or as a prefix, suffix, or fragment of another term, refers to a residue that contains carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as “substituted”, it can contain heteroatoms over and above the carbon and hydrogen members of the substituent residue. Thus, when specifically described as substituted, the hydrocarbyl residue can also contain halogen atoms, nitro groups, cyano groups, carbonyl groups, carboxylic acid groups, ester groups, amino groups, amide groups, sulfonyl groups, sulfoxyl groups, sulfonamide groups, sulfamoyl groups, hydroxyl groups, alkoxyl groups, or the like, and it can contain heteroatoms within the backbone of the hydrocarbyl residue. In some embodiments, the polydiorganosiloxane is a polydimethylsiloxane. In addition, the polydiorganosiloxane of the continuous phase can be further combined with polymers that are suitable for use as an encapsulating material. Suitable polymers for combining with the polydiorganosiloxane include poly(vinyl acetate), polyethylene, crosslinked poly(vinyl pyrrolidone), poly(methyl methacrylate), poly(lactic acid), polyhydroxyalkanoate, ethylcellulose, poly(vinyl acetate phthalate), poly(methacrylic acid-co-methyl methacrylate), and combinations thereof. In some embodiments, the continuous phase comprises at least about 50 weight percent of the polydiorganosiloxane. The continuous phase can comprise at least about 75 weight percent of the polydiorganosiloxane, specifically at least about 80 weight percent of the polydiorganosiloxane, and even more specifically at least about 90 weight percent of the polydiorganosiloxane, based on the total weight of the continuous phase.

In some embodiments, the continuous phase additionally contains a continuous phase texture modifier such as, for example, poly(vinyl acetate), fats, butyl rubber, talc, silica, or a combination thereof.

In some embodiments, the disperse phase containing the active ingredient can further contain a disperse phase texture modifier such as, for example, butyl rubber, talc, silica, and combinations thereof. The disperse phase texture modifier can be present in the disperse phase comprising the solid particles comprising the active ingredient. Alternatively, the disperse phase texture modifier can be present in a second disperse phase that is separate from the disperse phase comprising the solid particles comprising the active ingredient. In some embodiments, the disperse phase texture modifier is present in both a first disperse phase comprising the solid active ingredient particles and in a second disperse phase having only texture modifier, wherein the first disperse phase is separate from the second disperse phase.

In some embodiments, the continuous phase is present in the polydiorganosiloxane-encapsulated active ingredient in an amount of about 50 to about 95 weight percent, specifically about 55 to about 90 weight percent, more specifically about 60 to about 80 weight percent, and even more specifically about 65 to about 75 weight percent of the polydiorganosiloxane-encapsulated active ingredient; and the disperse phase is present in an amount of about 5 to about 50 weight percent, specifically about 10 to about 45 weight percent, more specifically about 20 to about 40 weight percent, and even more specifically about 25 to about 35 weight percent of the polydiorganosiloxane-encapsulated active ingredient, wherein the weight percents are based on the total weight of the polydiorganosiloxane-encapsulated active ingredient.

In one embodiment, the disperse phase has a number average particle size of about 2 to about 500 micrometers. In other embodiments, at least 75 weight percent of the disperse phase particles have a particle size of about 5 to about 200 micrometers. In some embodiments, the disperse phase has a maximum particle size less than or equal to about 500 micrometers.

The active ingredient can be selected from, for example, food-grade acids, flavorings, high-intensity sweeteners, oral care agents, antioxidants, nutraceuticals, pharmaceutical actives, and combinations thereof. In some embodiments, the active ingredient contains a food-grade acid. The food-grade acid can be any acid suitable for use in a comestible, including adipic acid, ascorbic acid, aspartic acid, benzoic acid, citric acid, fumaric acid, glutamic acid, maleic acid, malic acid, oxalic acid, sorbic acid, succinic acid, tartaric acid, and combinations thereof.

One or more active ingredients can be encapsulated in a polydiorganosiloxane to form a polydiorganosiloxane-encapsulated active ingredient that can be further incorporated into various comestibles. In one embodiment, the polydiorganosiloxane-encapsulated active ingredient is present in a chewing gum composition in a particulate form having a number average particle size of about 50 to about 4000 micrometers. In another embodiment, the polydiorganosiloxane-encapsulated active ingredient is present in the chewing gum composition in a particulate form, wherein the particulate form comprises at least 75 weight percent of particles having a particle size of about 75 to about 500 micrometers. In some embodiments, the polydiorganosiloxane-encapsulated active has a maximum particle size less than or equal to about 4000 micrometers.

In some embodiments, the gum composition further includes free active ingredients in addition to the polydiorganosiloxane-encapsulated active ingredients. The free active ingredients can include sweeteners, flavorings, high-intensity sweeteners, food-grade acids, oral care agents, antioxidants, nutraceuticals, pharmaceutical actives, and combinations thereof. The free active ingredients can be present in an amount of about 0.5 to about 15 weight percent based upon the chewing gum composition.

In some embodiments, the chewing gum composition comprises about 1 to about 20 weight percent of the polydiorganosiloxane-encapsulated active ingredient, based on the total weight of the chewing gum composition. Within this range, the amount of the polydiorganosiloxane-encapsulated active ingredient can be about 2 to about 15 weight percent, specifically about 3 to about 9 weight percent.

### Chewing Gum

As used herein, the terms “gum,” “chewing gum,” and “bubble gum” are used interchangeably and are meant to include any gum composition. With regard to chewing gum compositions, such compositions contain a gum base, the flavor enhancing composition, and various additives.

The gum compositions of the disclosed herein can be coated or uncoated, and be in the form of slabs, sticks, pellets, balls, and the like. The composition of the different forms of the gum compositions will be similar but can vary with regard to the ratio of the ingredients. For example, coated gum compositions can contain a lower percentage of softeners. Pellets and balls can have a chewing gum core, which has been coated with either a sugar solution or a sugarless solution to create the hard shell. Slabs and sticks are usually formulated to be softer in texture than the chewing gum core. In some cases, a hydroxy fatty acid salt or other surfactant actives can have a softening effect on the gum base. In order to adjust for any potential undesirable softening effect that the surfactant actives can have on the gum base, it can be beneficial to formulate a slab or stick gum having a firmer texture than usual (i.e., use less conventional softener than is typically employed).

Center-filled gum is another common gum form. The gum portion has a similar composition and mode of manufacture to that described above. However, the center-fill is typically an aqueous liquid or gel, which is injected into the center of the gum during processing. The encapsulated active ingredient(s) can, optionally, be incorporated into the center-fill during manufacture of the fill, incorporated directly or into the chewing gum portion of the total gum composition or both. The center-filled gum can also be optionally coated and can be prepared in various forms, such as in the form of a lollipop.

The chewing gum composition generally comprises a gum base, bulk sweeteners, high intensity sweeteners, flavorants, coloring agents, sensates, and any other optional additives, including throat-soothing agents, spices, tooth-whitening agents, breath-freshening agents, vitamins, minerals, caffeine, drugs (e.g., medications, herbs, and nutritional supplements), oral care products, and combinations thereof.

Generally, the chewing gum composition comprises a water insoluble gum base portion and a water-soluble bulk portion. The gum base can vary greatly depending upon various factors such as the type of gum base desired, the consistency of gum desired, and the other components used in the composition to make the final chewing gum product. The gum base can be any water-insoluble gum base known in the art, and includes those gum bases utilized for chewing gums and bubble gums. Illustrative examples of suitable polymers in gum bases include both natural and synthetic elastomers and rubbers. For example, natural elastomers and rubbers include substances of vegetable origin such as smoked or liquid latex and guayule, natural gums such as jelutong, lechi caspi, perillo, sorva, massaranduba balata, massaranduba chocolate, nispero, rosidinha, crown gum, chicle, gutta percha, gutta kataiu, gutta kay, niger gutta, tunu, chilte, chiquibul, gutta hang kang, and combinations thereof.

Synthetic elastomers include high- and low-molecular weight elastomers. Useful high molecular weight elastomers include butadiene-styrene copolymers, polyisoprene, polyisobutylene, isobutylene-isoprene copolymers, polyethylene, and combinations thereof. Useful low-molecular weight elastomers include polybutene, polybutadiene, polyisobutylene, and combinations thereof. Suitable gum bases can also include vinyl polymeric elastomers such as poly(vinyl acetate), polyethylene, vinyl copolymeric elastomers such as copolymers of vinyl acetate and vinyl laurate, copolymers of vinyl acetate and vinyl stearate, copolymers of ethylene and vinyl acetate, poly(vinyl alcohol) and combinations thereof. When utilized, the number average molecular weight of the vinyl polymers can be about 3,000 to about 94,000. Vinyl polymers such as poly(vinyl alcohol) and poly(vinyl acetate) (when employed in the gum base, as distinguished from the encapsulated food-grade acid) can have a number average molecular weight of about 8,000 to about 65,000. Furthermore, any combination of the aforementioned high- and low-molecular weight, natural and synthetic elastomers, and rubbers can be used as a gum base.

The amount of gum base employed will vary greatly depending upon various factors such as the type of base used, the consistency of the gum desired, and the other components used in the composition to make the final chewing gum product. In general, the gum base will be present in an amount of about 5 to about 94 weight percent of the final chewing gum composition. In some embodiments, the gum base amount is about 15 to about 45 weight percent, specifically about 15 to about 35 weight percent, more specifically about 20 to about 30 weight percent, based upon the total weight of the chewing gum product.

The water-insoluble gum base portion can further additionally contain any combination of elastomer plasticizers, texture modifiers, waxes, softeners, fillers and other optional ingredients such as colorants and antioxidants. Elastomer plasticizers are also commonly referred to as resins, resinous compounds, elastomer solvents, or rosins. Additives that can be included in the gum base include plasticizers, waxes or softeners that are used in effective amounts to provide a variety of desirable textures and consistency properties. Because of the low molecular weight of these components, the texture modifying agents are able to penetrate the fundamental structure of the gum base making it more plastic and less viscous.

The gum base composition can contain conventional elastomer plasticizers to aid in softening the elastomer base component, for example terpene resins such as polymers derived from alpha-pinene, beta-pinene, and/or d-limonene; methyl, glycerol or pentaerythritol esters of rosins or modified rosins and gums, such as hydrogenated, dimerized or polymerized rosins, or combinations comprising at least one of the foregoing resins; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like. Any combination of the foregoing elastomer plasticizers can be used to soften or adjust the tackiness of the elastomer base component. The elastomer plasticizer can be used in amounts of about 5 to about 75 weight percent of the gum base, specifically about 45 to about 70 weight percent of the gum base.

Suitable softeners include lanolin, palmitic acid, oleic acid, stearic acid, fatty acids, sodium stearate, potassium stearate, glyceryl triacetate, glyceryl lecithin, glyceryl monostearate, propylene glycol monostearate, monoglycerides, diglycerides, triglycerides, acetylated monoglycerides, glycerin, lecithin, diacetin, and combinations thereof. Other suitable softeners include waxes. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, cocoa butter, propylene glycol, and combinations thereof can also be incorporated into the gum base to obtain a variety of desirable textures and consistency properties.

In some embodiments, the chewing gum contains texture modifiers for modifying the texture of the chewing gum. In some embodiments, the chewing gum contains texture modifiers such as, for example, poly(vinyl acetate), fats, butyl rubber, talc, silica, and combinations thereof.

In some embodiments, the chewing gum composition further contains a gum base softener. Softeners include, for example, lanolin, palmitic acid, oleic acid, stearic acid, fatty acids, sodium stearate, potassium stearate, glyceryl triacetate, glyceryl lecithin, glyceryl monostearate, propylene glycol monostearate, monoglycerides, diglycerides, triglycerides, acetylated monoglycerides, glycerin, lecithin, diacetin, waxes, and combinations thereof. In some embodiments, the softener is present in amounts of up to about 30 weight percent of the gum base, specifically about 3 to about 20 weight percent of the gum base.

When a wax is present in the gum base, it softens the polymeric elastomer mixture and improves the elasticity of the gum base. The waxes employed can have a melting point below about 60 degrees Celsius, and preferably between about 45 and about 55 degrees Celsius. The low melting wax can be a paraffin wax. The wax can be present in the gum base in an amount of about 6 to about 10 weight percent, and preferably about 7 to about 9.5 weight percent, based on the weight of the gum base.

In addition to the low melting point waxes, waxes having a higher melting point can be used in the gum base in amounts up to about 5 weight percent of the gum base. Such high melting waxes include beeswax, vegetable wax, rice bran wax, candelilla wax, carnauba wax, polyethylene wax, microcrystalline wax, most petroleum waxes, and mixtures thereof.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and combinations thereof, which can serve as fillers and textural agents. These fillers or adjuvants can be used in the gum base in various amounts. Specifically the amount of filler, when used, can be present in an amount of greater than about 15 weight percent and up to about 40 weight percent, specifically about 20 to about 30 weight percent, based on the weight of the gum base.

In addition to a water insoluble gum base portion, a typical chewing gum composition includes a water-soluble bulk portion and one or more flavoring agents. In some embodiments, an unencapsulated active ingredient is present in a water-soluble bulk portion of the chewing gum composition. The water-soluble portion can include bulk sweeteners, high-intensity sweeteners, flavoring agents, softeners, emulsifiers, coloring agents, acidulants, fillers, antioxidants, and other conventional chewing gum additives that provide desired attributes. Any of the above-mentioned water-soluble active ingredients can also be incorporated into the water-soluble bulk portion of chewing gum composition. These and other conventional chewing gum additives known to one having ordinary skill in the art can also be incorporated into the gum base.

As mentioned above, a wide variety of one or more conventional additives can be used in the chewing gum composition, including sweeteners, high intensity sweeteners, flavor modulators and potentiators, flavorants/flavorings, coloring agents, medicaments, oral care agents, throat care agents, breath fresheners, mineral adjuvants, bulking agents, acidulants, buffering agents, sensates (e.g., warming agents, cooling agents, tingling agents, effervescing agents), thickeners, mouth moisteners, flavor enhancing compositions, antioxidants (e.g., butylated hydroxytoluene, butylated hydroxyanisole, or propyl gallate), preservatives, emulsifiers, thickening agents, and combinations thereof. Some of these additives can serve more than one purpose. For example, a sweetener such as sucrose, sorbitol or other sugar alcohol, or combinations of the foregoing and below-mentioned sweeteners, can also function as a bulking agent. In addition, combinations of the foregoing additives are often used.

In some embodiments, the chewing gum includes a sweetening agent to provide a sweet taste to the gum composition. Sweetening agents can include sugar sweeteners, sugarless sweeteners, high intensity sweeteners, and combinations thereof.

Sugar sweeteners generally include saccharides. Suitable sugar sweeteners include monosaccharides, disaccharides, and polysaccharides. Specific sugar sweeteners include sucrose (sugar), dextrose, maltose, dextrin, xylose, ribose, glucose, mannose, galactose, fructose (levulose), lactose, invert sugar, fructooligosaccharide syrups, partially hydrolyzed starch, corn syrup solids, such as high fructose corn syrup, and combinations thereof.

Suitable sugarless sweetening agents include sugar alcohols (or polyols) such as sorbitol, xylitol, mannitol, galactitol, maltitol, hydrogenated isomaltulose (isomalt), lactitol, erythritol; hydrogenated starch hydrolysate; stevia; and combinations thereof.

Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates include LYCASIN, a line of commercially available products manufactured by Roquette Freres of France, and HYSTAR, a line of commercially available products manufactured by Lonza, Inc., of Fair Lawn, N.J., USA.

A “high intensity sweetener” as used herein means agents having a sweetness at least 100 times that of sugar (sucrose) on a per weight basis, specifically at least 500 times that of sugar on a per weight basis. In one embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Any combination comprising one or more high intensity sweetener can be used. One or more of the high intensity sweeteners can further be combined with one or more of the foregoing sweeteners or sweetening agents.

Representative categories and examples of high-intensity sweeteners include water-soluble sweetening agents such as dihydrochalcones, monellin, steviosides, Rebaudioside A, Rebaudioside B, Rebaudioside C, glycyrrhizin, dihydroflavenol, (2S,4S)-4-Amino-2-hydroxy-2-(1H-indol-3-ylmethyl)-pentanedioic acid (monatin), and L-aminodicarboxylic acid aminoalkenoic acid ester amides, such as those disclosed in U.S. Pat. No. 4,619,834 to Zanno et al., and combinations thereof; water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination comprising at least one of the foregoing; dipeptide based sweeteners, for example the L-aspartic acid derived sweeteners such as L-aspartyl-L-phenylalanine methyl ester (Aspartame) and materials described in U.S. Pat. No. 3,492,131 to Schlatter et al., L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenyl-glycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalamine methyl ester (Neotame), and combinations thereof; water-soluble sweeteners derived from naturally occurring water-soluble sweeteners, such as steviosides, Rebaudioside A, Rebaudioside B, Rebaudioside C, chlorinated derivatives of ordinary sugar (sucrose), e.g., mogrosides (Luo han Guo), chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include 1-chloro-1′-deoxysucrose; 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalactosucrose; 4,6,1′,6′-tetradeoxy-sucrose, or a combination thereof; protein based sweeteners such as thaumaoccous danielli, thaumatin, talin, or a combination thereof; and amino acid based sweeteners. In some embodiments, the sweeteners include sorbitol, mannitol, aspartame, acesulfame potassium salt, monatin, and combinations thereof.

The high intensity sweetener can be used in a variety of distinct physical forms, for example those known in the art to provide an initial burst of sweetness and/or a prolonged sensation of sweetness. Such physical forms include free forms (e.g., spray dried or powdered), beaded forms, encapsulated forms, and combinations thereof.

In some embodiments, the active ingredient that is encapsulated by the polydiorganosiloxane contains a high-intensity sweetener, any of the high-intensity sweeteners described above are suitable for use. In some embodiments, the encapsulated high-intensity sweetener can include dihydrochalcones, monellin, Rebaudioside A, Rebaudioside B, Rebaudioside C, steviosides, glycyrrhizin, dihydroflavenol, saccharin, saccharints, cyclamate salts, acesulfame salts, L-aspartyl-L-phenylalanine methyl ester (Aspartame), L-alpha-aspartyl-N-(2,2,4,4-tetramethyl-3-thietanyl)-D-alaninamide hydrate (Alitame), L-alpha-aspartyl-L-phenylglycine methyl ester, L-alpha-aspartyl-L-2,5-dihydrophenylglycine methyl ester, L-alpha-aspartyl-2,5-dihydrophenylalanine methyl ester; L-aspartyl-L-(1-cyclohexen)alanine, N—(N-(3,3-dimethylbutyl)-L-alpha-aspartyl)-L-phenylalamine methyl ester (Neotame), steviosides, 1,6-dichloro-1,6-dideoxy-β-D-fructofuranosyl-4-chloro-4-deoxy-α-D-galactopyranoside (Sucralose), thaumatin, talin, and combinations thereof.

In a chewing gum, a sweet taste can come from flavor modulators or potentiators and/or from flavorants as well as from sweeteners. Flavor potentiators consist of materials that intensify, supplement, modify, or enhance the taste or aroma perception of an original material without introducing a characteristic taste or aroma perception of their own. Flavor modulators can impart a characteristic of their own that complements or negates a characteristic of another component. In some embodiments, flavor modulators or potentiators are designed to intensify, supplement, modify, or enhance the perception of flavor, sweetness, tartness, umami, kokumi, saltiness and combinations thereof can be included. Thus, the addition of flavor modulators or potentiators can impact the overall taste of the comestible. For example, flavors can be compounded to have additional sweet notes by the inclusion of flavor modulators or potentiators, such as vanilla, vanillin, ethyl maltol, furfual, ethyl propionate, lactones, and combinations thereof.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2R5 and T1R5), and combinations thereof. In some embodiments, sugar acids, sodium chloride, potassium chloride, sodium acid sulfate, or a combination thereof is used. In other embodiments, glutamates such as monosodium glutamate, monopotassium glutamate, hydrolyzed vegetable protein, hydrolyzed animal protein, yeast extract, and combinations thereof are used. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

The amount of flavor modulators, flavor potentiators, and flavorants used herein can be a matter of preference subject to such factors as the type of final comestible product composition, the individual flavor, the confectionary base employed, and the strength of flavor desired. Thus, the amount of flavoring can be varied in order to obtain the result desired in the final product and such variations are within the capabilities of those skilled in the art without the need for undue experimentation.

In some embodiments, the chewing gum can contain aroma agents and/or flavoring agents including natural and synthetic flavorings such as natural vegetable components, flavoring aromatics and/or oils, essential oils, essences, extracts, powders, food-grade acids, oleoresins, and extracts derived from plants, leaves, flowers, fruits, and combinations thereof. The flavorings can be in liquid or powdered form.

Examples of artificial, natural and synthetic fruit flavorings include coconut, coffee, chocolate, vanilla, lemon, grapefruit, orange, lime, yazu, sudachi, menthol, licorice, caramel, honey, peanut, walnut, cashew, hazelnut, almond, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and combinations thereof.

Other flavors whose release profiles can be managed include a milk flavor, a butter flavor, a cheese flavor, a cream flavor, a yogurt flavor, a vanilla flavor, a tea or coffee flavor such as a green tea flavor and an oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, tomato, and combinations thereof. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the composition can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray-drying a liquid can be used. Alternatively, the flavoring agent can be absorbed onto water-soluble materials, such as cellulose, starch, sugar, maltodextrin, gum arabic and so forth or it can be encapsulated. In still other embodiments, the flavoring agent can be adsorbed onto silicas or zeolites. The particle size of the flavorings can be less than 3 millimeters, less than 2 millimeters or preferably less than 1 millimeter, calculated as the longest dimension of the particle. The natural flavoring agent can have a particle size of about 3 micrometers to about 2 millimeters, specifically about 4 micrometers to about 1 millimeter.

Various synthetic flavors, such as mixed fruit flavors, can also be used in the chewing gum. The aroma agent can be used in quantities smaller than those conventionally used. The aroma agents and/or flavors can be used in the amount of about 0.01 to about 30 weight percent of the gum composition depending on the desired intensity of the aromas and/or flavors used. Preferably, the content of the aromas and/or flavors is in the range of about 0.2 to about 3 weight percent of the gum composition.

In some embodiments, the encapsulated active ingredient further contains a flavoring, and any of the flavorings described herein are suitable for use. The flavoring can include a powder flavor, a liquid flavor, a natural vegetable component, a flavoring aromatic, a flavoring oil, an essential oil, an essence, an extract, a food-grade acid, an oleoresin, a plant extract, a flower extract, a fruit extract, and combinations thereof.

The chewing gum can further include cooling and warming agents. Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, monomenthyl succinate, monomenthyl methyl succinate, monomenthyl glutarate, menthyl 2-pyrrolidone-5-carboxylate, monomenthyl 3-methyl maleate, menthyl acetate, menthyl lactate, menthyl salicylate, 2-isopropanyl-5-methylcyclohexanol, 3-L-menthoxypropane-1,2-diol, menthane, menthone, menthone ketals, menthone glycerol ketals, menthyl glutarate esters, N-ethyl-p-menthane-3-carboxamide (WS-3), and combinations thereof.

Other coolants can be used in combination with the menthyl-based coolant, for example 2-mercapto-cyclodecanone, hydroxycarboxylic acids with 2 to 6 carbon atoms, N,2,3-trimethyl-2-isopropyl butanamide, xylitol, erythritol, alpha-dimethyl succinate, methyl lactate, and combinations thereof.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol methyl ether, vanillyl alcohol ethyl ether, vanillyl alcohol n-propyl ether, vanillyl alcohol isopropyl ether, vanillyl alcohol isobutylether, vanillyl alcohol n-pentyl ether, vanillyl alcohol isoamyl ether, vanillyl alcohol n-hexylether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerin, and combinations thereof.

Coloring agents (colorants, colorings) can be used in amounts effective to produce a desired color for the chewing gum. Suitable coloring agents include pigments, which can be incorporated in amounts up to about 6 weight percent of the chewing gum composition. For example, titanium dioxide can be incorporated in amounts up to about 2 weight percent, and specifically less than about 1 weight percent by weight of the chewing gum composition.

Suitable coloring agents also include natural food colors and dyes suitable for food, drug, and cosmetic applications. Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof.

Exemplary breath fresheners include to zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, and combinations thereof. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, and combinations thereof. Aldehydes such as cinnamic aldehyde and salicylaldehyde can be used. Additionally, chemicals such as menthol, carvone, iso-garrigol, and anethole can function as breath fresheners.

In one embodiment, the comestible product comprises a flavor enhancing composition that imparts a taste-masking effect for comestible product orally consumed by an individual. The flavor enhancing composition comprises sweeteners, high intensity sweeteners, flavor modulators, flavor potentiators, flavoring agents, sensates, and combinations thereof.

Exemplary mouth moisteners include saliva stimulators such as acids and salts including acetic acid, adipic acid, ascorbic acid, butyric acid, citric acid, formic acid, fumaric acid, glyconic acid, lactic acid, malic acid, oxalic acid, succinic acid, and tartaric acid. Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included such as microcrystalline cellulose, carboxymethylcellulose (CMC), methylcellulose (MC), hydroxypropylmethylcellulose (HPMC), hydroxypropylcellulose (MPC), and combinations thereof.

Similarly, humectants, which can provide a perception of mouth hydration, can be included. Such humectants can include glycerol, sorbitol, polyethylene glycol, erythritol, xylitol, and combinations thereof. Additionally, in some embodiments, fats can provide a perception of mouth moistening. Such fats can include medium chain triglycerides, vegetable oils, fish oils, mineral oils, and combinations thereof.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof.

The relative amounts of each of the components of the chewing gum composition will depend on the identity of the particular component of the chewing gum composition, as well as, the desired flavor of the chewing gum composition, and are readily determined by one of ordinary skill in the art.

In some embodiments, a tingling sensation can be provided. Tingling agents include jambu, and alkylamides extracted from materials such as jambu or sanshool.

Additionally, a sensation can be created due to effervescence. Such effervescence is created by combining a basic material with an acidic material. In some embodiments, the basic material can include alkali metal carbonates, alkali metal bicarbonates, alkaline earth metal carbonates, alkaline earth metal bicarbonates, and mixtures thereof. In some embodiments, the acidic material can include acetic acid, adipic acid, ascorbic acid, butyric acid, citric acid, formic acid, fumaric acid, glyconic acid, lactic acid, malic acid, oxalic acid, succinic acid, tartaric acid, and combinations thereof.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include hydrolytic agents including proteolytic enzymes; abrasives such as hydrated silica, calcium carbonate, sodium bicarbonate and alumina; other active stain-removing components such as surface-active agents, including anionic surfactants such as sodium stearate, sodium palmitate, sulfated butyl oleate, sodium oleate, and sodium lauryl sulfate; salts of fumaric acid; glycerol; hydroxylated lecithin; and chelators such as polyphosphates, which are typically employed as tartar control ingredients. Oral care ingredients can also include tetrasodium pyrophosphate and sodium tri-polyphosphate, sodium bicarbonate, sodium acid pyrophosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphospate, and combinations thereof. In some embodiments, potassium nitrate and potassium citrate are included. Other examples include casein glycomacropeptide, calcium casein peptone-calcium phosphate, casein phosphopeptides, casein phosphopeptide-amorphous calcium phosphate (CPP-ACP), and amorphous calcium phosphate. Still other examples include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents can include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and combinations thereof. Examples of the last mentioned amides are N-lauroyl sarcosine, and the sodium, potassium, and ethanolammonium salts of N-lauroyl sarcosine, N-myristoyl sarcosine, and N-palmitoyl sarcosine.

In addition to surfactants, oral care ingredients can include antibacterial agents such as triclosan, chlorhexidine, zinc citrate, silver nitrate, copper, limonene, and cetyl pyridinium chloride, and combinations thereof.

Anticaries agents can include fluoride ion sources such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chlorofluoride, and combinations thereof. Further examples of anticaries agents are included in U.S. Pat. No. 5,227,154 to Reynolds, U.S. Pat. No. 5,378,131 to Greenberg and U.S. Pat. No. 6,685,916 to Holme et al.

Throat care or throat-soothing ingredients include analgesics, antihistamines, anesthetics, demulcents, mucolytics, expectorants, antitussive, and antiseptics. In some embodiments, throat-soothing agents include honey, propolis, aloe vera, glycerin, menthol and combinations thereof are employed.

Additional bulking agents (carriers, extenders) suitable for use include sweetening agents such as monosaccharides, disaccharides, polysaccharides, sugar alcohols, polydextrose, maltodextrins, minerals, such as calcium carbonate, talc, titanium dioxide, dicalcium phosphate, and combinations thereof. Bulking agents can be used in amounts up to about 90 weight percent of the chewing gum composition, specifically about 40 weight percent to about 70 weight percent, and about 50 weight percent to about 65 weight percent of the chewing gum composition.

Suitable emulsifiers include distilled monoglycerides, acetic acid esters of monoglycerides and diglycerides, citric acid esters of monoglycerides and diglycerides, lactic acid esters of monoglycerides and diglycerides, monoglycerides and diglycerides, polyglycerol esters of fatty acids, polyethylene glycol ethers of cetearyl alcohol (e.g., CETEARETH-20), polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of monoglycerides and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl-10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, the poly(oxyethylene) sorbitan fatty acid esters sold under the trade name TWEEN, the sorbitan fatty acid esters sold under the trade name SPAN, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, and combinations thereof.

Suitable thickening agents include cellulose ethers (e.g., hydroxyethylcellulose, hydroxypropylmethylcellulose, or hydroxypropylcellulose), methylcellulose, carboxymethylcellulose, and combinations thereof. Additional polymers useful as thickeners include the acrylic acid polymers and copolymer sold under the trade name CARBOMER, poly(vinyl pyrrolidone), poly(vinyl alcohol), sodium alginate, polyethylene glycol, natural gums like xanthan gum, tragacantha, guar gum, acacia gum, arabic gum, water-dispersible polyacrylates like poly(acrylic acid), methyl methacrylate copolymers, carboxyvinyl copolymers, and combinations thereof.

In some embodiments, the chewing gum can deliver multiple, distinct flavors to the consumer resulting in a flavor-changing gum composition. In one embodiment, the chewing gum composition contains a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient; and further contains at least a first flavor composition and a second flavor composition, wherein the first flavor composition begins to release from the chewing gum when the chewing gum composition is masticated, and the second flavor composition comprises the food grade acid and begins to release after the first flavor composition begins to release. In some embodiments, the second flavor composition comprises the polydiorganosiloxane-encapsulated active ingredient that comprises a continuous phase comprising a polydiorganosiloxane and a disperse phase comprising solid particles comprising an active ingredient.

In some embodiments, the chewing gum composition contains an encapsulated active ingredient, as described herein; and further contains at least one first flavor composition, a second flavor composition and a third flavor composition, wherein the first flavor composition begins to release from the chewing gum when the chewing gum composition is masticated, the second flavor composition comprises the food grade acid and begins to release after the first flavor composition has begun to release, and the third flavor composition releases after the second flavor composition begins to release. In some embodiments, the second flavor composition comprises the polydiorganosiloxane-encapsulated active ingredient that comprises a continuous phase comprising a polydiorganosiloxane and a disperse phase comprising solid particles comprising an active ingredient. In other embodiments, the third flavor composition is the polydiorganosiloxane-encapsulated active ingredient that comprises a continuous phase comprising a polydiorganosiloxane and a disperse phase comprising solid particles comprising an active ingredient. In still other embodiments, both the second and the third flavor compositions comprise the polydiorganosiloxane-encapsulated active ingredient that comprises a continuous phase comprising a polydiorganosiloxane and a disperse phase comprising solid particles comprising an active ingredient.

In other embodiments, the chewing gum composition delivers multiple, distinct flavors such as, for example, sweet flavors, sour flavors, fruit flavors, mint flavors and combinations thereof, including any of the flavorings and/or sensates disclosed herein. In some embodiments, the sweet flavors can be flavor compositions having at least one sweetener and the sour flavors can be flavor compositions having at least one food-grade acid. In other embodiments, the sweet flavors and sour flavors can be flavor compositions having any combination of sweeteners and food grade acids.

The sweet and sour flavors can be released in any sequential order or combination. In some embodiments, the second flavor composition has a food-grade acid. In other embodiments, the third flavor composition has a food-grade acid. In still other embodiments, both the second and third flavor compositions have a food-grade acid. For example, in one embodiment of the chewing gum composition the first flavor composition has a sweetener and the second flavor composition has a food grade acid. In other embodiments, the first flavor composition has a sweetener, the second flavor composition has a food-grade acid, and the third flavor composition has a sweetener. In still other compositions, the first flavor composition has a sweetener, the second flavor composition has a food-grade acid, and the third flavor composition has a food-grade acid.

In some embodiments, the first flavor composition releases for about 5 minutes to about 7 minutes after mastication begins and the second flavor composition releases for about 8 minutes to about 10 minutes after mastication begins. In other embodiments, the first flavor composition releases for about 5 minutes to about 7 minutes after mastication begins, the second flavor composition releases for about 8 minutes to about 10 minutes after mastication begins, and the third flavor composition releases for about for about 10 minutes to about 30 minutes after mastication begins. In other embodiments, the first flavor composition releases for about 6 minutes to about 7 minutes after mastication begins, the second flavor composition releases for about 7 minutes to about 12 minutes after mastication begins, and the third flavor composition releases for about for about 12 minutes to about 30 minutes after mastication begins.

Some embodiments are methods of preparing or forming the polydiorganosiloxane-encapsulated active. In one method, the polydiorganosiloxane-encapsulated active is formed prior to incorporating the encapsulated active into the chewing gum composition. The polydiorganosiloxane-encapsulated active is formed by dispersing solid particles of an active ingredient into a curable polydiorganosiloxane composition; and then curing the curable polydiorganosiloxane composition to form the polydiorganosiloxane-encapsulated active ingredient.

The curable polydiorganosiloxane composition can be cured using various catalysts and catalytic reactions. For example, the polydiorganosiloxane composition can be cured using a platinum catalyst; a platinum-alloy catalyst; an organometallic catalyst such as a transition metal alkoxide or a post-transition metal alkoxide; or a peroxide catalyst. In some embodiments, the polydiorganosiloxane composition is cured using a peroxide catalyst. In embodiments, the peroxide catalyst is selected from hydrogen peroxide, alkyl peroxides, dialkyl peroxides, benzoyl peroxides, acetone peroxides, ketone peroxides, methyl ethyl ketone peroxide, dilauroylperoxide, di-tert-butyl peroxide, tert-butyl peroxybenzoate, tertbutyl hydroperoxide, and combinations thereof. In some embodiments, the polydiorganosiloxane composition is cured using a hydrosilylation reaction. The polydiorganosiloxane composition can be cured using a platinum catalyst to catalyze the hydrosilylation reaction in the curable composition. In other embodiments, the polydiorganosiloxane composition is cured using a vinyl polymerization reaction. The polydiorganosiloxane composition can be cured using an alkyl peroxide catalyst to catalyze the vinyl polymerization reaction in the curable composition. In other embodiments, the polydiorganosiloxane composition can be cured through condensation curing. The polydiorganosiloxane composition can cured using a tin alkoxide catalyst to catalyze the condensation curing in the curable composition.

In some embodiments, the polydiorganosiloxane-encapsulated active is formed by dispersing solid particles comprising at least one active ingredient into the curable polydiorganosiloxane composition prior to curing the composition. In some embodiments, the resultant mixture is blended in a high-shear mixer such as a single- or twin-screw extruder, a sigma mixer, or a Banbury mixer. In some embodiments, the mixture of solid particles comprising the active ingredient and the polydiorganosiloxane composition is then extruded into a thin film and subsequent thermal crosslinking of the polydiorganosiloxane composition occurs to form a cured thin film of polydiorganosiloxane-encapsulated active ingredient. In some embodiments, the cured thin film is then cooled and subsequently processed into a particulate form.

In some embodiments, a texture modifier is incorporated into the continuous phase by dispersing the texture modifier into the curable composition prior to curing the polydiorganosiloxane composition. In some exemplary embodiments, the texture modifier includes poly(vinyl acetate), fats, butyl rubber, talc, silica, or a combination thereof.

Once curing of the polydiorganosiloxane is complete, the polydiorganosiloxane-encapsulated active ingredient can be further processed into particles or pieces by grinding, sieving, screening, cutting, crushing, compressing, or milling, e.g., hammer milling or ball milling. Once the polydiorganosiloxane-encapsulated active ingredient is processed to the desired particle size it is stored in a cool, dry place. In some embodiments, the particles are further processed by dividing the polydiorganosiloxane-encapsulated active ingredient into particles having a number average particle size of about 75 to about 500 micrometers. In some embodiments, the polydiorganosiloxane-encapsulated active is then incorporated into a chewing gum by dispersing the pieces or particles of polydiorganosiloxane-encapsulated active into a chewing gum base and blending the chewing gum composition in a high-shear mixer such as a single- or twin-screw extruder, a sigma blade mixer, or a Banbury mixer.

This disclosure further comprises methods of preparing an encapsulated active and a chewing gum containing the same. Some embodiments include a method for preparing the gum compositions, including both chewing gum and bubble gum compositions. The chewing gum compositions can be prepared using any standard techniques and equipment known to those skilled in the art. The apparatus useful in accordance with some embodiments comprises mixing and heating apparatus well known in the chewing gum manufacturing arts, and therefore the selection of the specific apparatus will be apparent to the artisan.

In one exemplary process, a gum base is heated to a temperature sufficiently high to soften the base without adversely effecting the physical and chemical make up of the base, which will vary depending upon the composition of the gum base used, and is readily determined by those skilled in the art without undue experimentation. For example, the gum base can be melted to about 60 to about 160 degrees Celsius, or melted to about 150 to about 175 degrees Celsius, for a period of time sufficient to render the base molten, for example, about thirty minutes, just prior to being admixed incrementally with the remaining ingredients of the base such as the plasticizer, fillers, the bulking agent or sweeteners, the softener and coloring agents to plasticize the blend as well as to modulate the hardness, viscoelasticity and formability of the base, and the flavor enhancing composition (as a concentrate with other additives or separately). Mixing is continued until a uniform mixture of the gum composition is obtained. The resulting chewing gum composition is allowed to cool. Thereafter the gum composition mixture can be formed into desirable gum shapes, i.e., stick, slab, pellet, ball, or the like. The sized chewing gum can be conditioned for about one day prior to packaging the chewing gum.

In some embodiments, gum pieces can be coated with an aqueous coating composition, which can be applied by any method known in the art. The coating composition can be present in an amount of about 25 to about 35 weight percent of the total gum piece.

The outer coating can be hard or crunchy. In some embodiments, the outer coating includes sorbitol, maltitol, xylitol, isomalt, or another crystallizable polyol; sucrose can also be used. Flavorants can also be added to yield unique product characteristics.

The coating, if present, can include several opaque layers, such that the chewing gum composition is not visible through the coating itself, which can optionally be covered with a further one or more transparent layers for aesthetic, textural and protective purposes. The outer coating can also contain small amounts of water and gum arabic. The coating can be further coated with wax. The coating can be applied by successive applications of a coating solution, with drying in between each coat. As the coating dries it usually becomes opaque and is usually white, though other colorants can be added. A polyol coating can be further coated with wax. The coating can further include colored flakes or speckles.

If the composition comprises a coating, it is possible that one or more of the above-mentioned active ingredients can be dispersed throughout the coating. This can be useful if one or more of the active ingredients is incompatible in a single-phase composition with another of the actives.

The coating can be formulated to assist with increasing the thermal stability of the gum piece and preventing leaking of a liquid fill if the gum product is a center-filled gum. In some embodiments, the coating can include a gelatin composition. The gelatin composition can be added as a 40 weight percent solution and can be present in the coating composition about 5 to about 10 weight percent of the coating composition, and more specifically about 7 to about 8 weight percent of the coating solution. The gel strength of the gelatin can be about 130 bloom to about 250 bloom.

Additives, such as physiological coolants, throat-soothing agents, spices, warming agents, oral care agents, medicaments, vitamins, caffeine, and conventional additives can be included in any or all portions of the chewing gum composition. Such components can be used in amounts sufficient to achieve their intended effects.

The features and advantages are more fully shown by the following examples, which are provided for purposes of illustration and are not to be construed as limiting the invention in any way.

All parts and percentages in the examples and throughout the specification and claims are by weight of the final composition unless otherwise specified.

### Comparative Example 1

Comparative Example 1 illustrates the encapsulation of citric acid in poly(vinyl acetate). Poly(vinyl acetate) (550 grams) was melted at a temperature of about 110 degrees Celsius. The poly(vinyl acetate) was melted in a high-shear mixer such as a single-screw or twin-screw extruder, a sigma mixer, or a Banbury mixer. Glycerol monostearate (50 grams) was then added to the molten poly(vinyl acetate). Next, citric acid (450 grams) having a number average particle size of 75 microns was added to the resultant mixture and mixed under high shear to completely disperse the ingredients. The resulting filled polymer melt was cooled and ground to a number average particle size of less than 420 microns. The encapsulated citric acid matrix was stored in an air-tight container at low humidity of below 35 degrees Celsius.

### Comparative Example 2

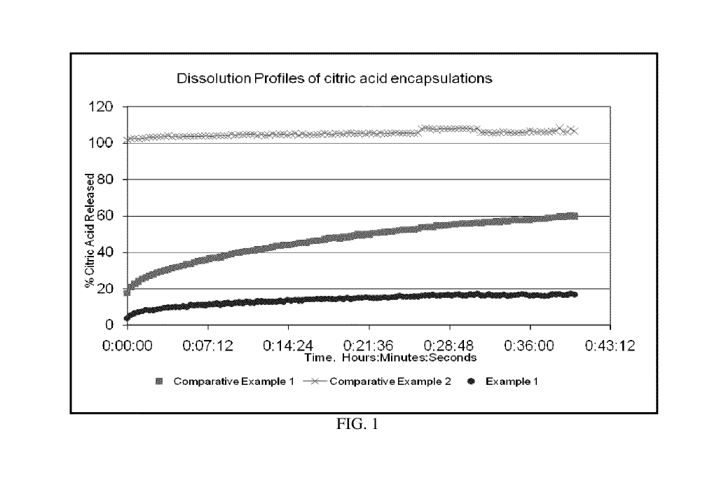

Comparative Example 2, as shown in FIG. 1, represents the encapsulation of citric acid in hydrogenated oil. The citric acid encapsulate is manufactured by spray coating hydrogenated oil onto citric acid particles in a fluidized bed coating process. The citric acid encapsulate is part of a line of commercially available products manufactured by Balchem Corporation, of New Hampton, N.Y., USA.

### Example 1

This example illustrates an encapsulation of citric acid in a platinum-cured polydimethylsiloxane. The two parts of a curable silicone composition obtained as MED-4735 from NuSil Silicone Technology (175 grams total) were blended in the presence of citric acid (75 grams; having a number average particle size of about 75 micrometers) and were cured a minimum of 10 minutes at a temperature of 116 degrees Celsius to form a film having a thickness of about 0.1-0.5 millimeters. The composition of the film was about 30 percent by weight citric acid and about 70 percent by weight polydimethylsiloxane. The film was then allowed to stabilize for a minimum of 24 hours at room temperature, after which it was cut to yield particles of polydimethylsiloxane-encapsulated citric acid having a number average particle size of about 200 to about 800 micrometers.

FIG. 1 shows the citric acid release rates for the encapsulated compositions of Comparative Examples 1-2 and Example 1. The release rates were determined as follows. The dissolution experiments were run in a DISTEK Dissolution System Model 2100 with an online ultraviolet measurement detector (Model OD LITE UV Fiber Optic). The dissolution equipment parameters were set as follows: the stirring speed is set to 350 revolutions per minute, the dissolution media was de-ionized water, the circulating water temperature was 22 degrees Celsius, the total number of readings was 120, the reading interval was every 20 seconds, and ultraviolet detector analytical wavelength was 210 nanometers. The procedure for analyzing the citric acid release rates was as follows. The dissolution vessels were filled with 500 milliliters of de-ionized water. The detector probes were then lowered into the filled dissolution vessels. The contents of the dissolution vessels were then stirred and 12.5 grams of encapsulated citric acid was added to each individual dissolution vessel, as described in Example 1, and Comparative Examples 1-2, and begin data collection. At the end of the dissolution experiment (40 minutes) the results of the dissolution data were plotted, as shown in FIG. 1. As shown in FIG. 1, the rate of release of the citric acid in descending order from the quickest release rate to the slowest release rate occurs as follows: Comparative Example 1 (fat encapsulation provided by Balchem Corporation)>Comparative Example 2 (poly(vinyl acetate) encapsulation)>Example 1 (platinum-cured polydimethylsiloxane encapsulation). Thus, polydimethylsiloxane encapsulated citric acid showed a significantly slower release rate when compared to the citric acids encapsulated in either fat (hydrogenated oil) or poly(vinyl acetate). Further, the sensory release and chew-out release studies conducted on chewing gums having citric acid encapsulated in fat (hydrogenated oil), poly(vinyl acetate) (B100), and silicone rubber show the same trend with respect to the release rates of citric acid from the chewing gum compositions.

### Example 2

This example illustrates an encapsulation of acesulfame-K in a platinum-cured polydimethylsiloxane. The two parts of a curable silicone composition (175 grams, total weight) obtained as MED-4735 from NuSil Silicone Technology was blended in a 50:50 weight ratio in the presence of acesulfame-K (75 grams; having a number average particle size of about 45 micrometers) and was cured at 90 degrees Celsius for 20 minutes to form a film having a thickness of about 0.1-0.5 millimeters and comprising about 30 weight percent acesulfame-K and about 70 weight percent polydimethylsiloxane. The film was then allowed to stabilize for 24 hours at room temperature, after which it was cut to yield particles of polydimethylsiloxane-encapsulated acesulfame-K having a number average particle size of about 200 to about 800 micrometers.

### Example 3

This example illustrates an encapsulation of citric acid in a platinum-cured polydimethylsiloxane. The three parts of a curable silicone composition (175 grams, total) obtained as MEDS-6382 from NuSil SiliconeTechnology was mixed thoroughly for a minimum of two minutes at a ratio of 97:2.50:0.50 (base:crosslinker:catalyst) in the presence of citric acid (75 grams; having a number average particle size of about 75 micrometers) and was cured for about 30 minutes at a temperature of 23 degrees Celsius to form a film having a thickness of about 0.1-0.5 millimeters. The composition of the citric acid/silicone rubber matrix was about 30 percent by weight citric acid and about 70 percent by weight polydimethylsiloxane. The film was then allowed to stabilize for a minimum of 20 minutes at ambient temperature and humidity, after which it was cut to yield particles of polydimethylsiloxane-encapsulated citric acid having a number average particle size of about 200 to about 800 micrometers.

### Example 4

This example illustrates an encapsulation of sucralose in a platinum-cured polydimethylsiloxane. The three parts of a curable silicone composition (175 grams, total) obtained as MEDS-6382 from NuSil SiliconeTechnology are mixed thoroughly for a minimum of two minutes at a ratio of 97:2.50:0.50 (base:crosslinker:catalyst) in the presence of sucralose (75 grams; having a number average particle size of about 10 micrometers) and cured for about 30 minutes at a temperature of 23 degrees Celsius to form a film having a thickness of about 0.1-0.5 millimeters. The composition of the sucralose/silicone rubber matrix is about 30 percent by weight sucralose and about 70 percent by weight polydimethylsiloxane. The film is then allowed to stabilize for a minimum of 20 minutes at ambient temperature and humidity, after which it is cut to yield particles of polydimethylsiloxane-encapsulated sucralose having a number average particle size of about 200 to about 800 micrometers.

### Example 5

This example illustrates an encapsulation of saccharin in a platinum-cured polydimethylsiloxane. The two parts of a curable silicone composition (175 grams, total weight) obtained as MED-4735 from NuSil Silicone Technology are blended in a 50:50 weight ratio in the presence of saccharin (75 grams; having a number average particle size of about 18 micrometers) and cured at 90 degrees Celsius for 20 minutes to form a film having a thickness of about 0.1-0.5 millimeters and comprising about 30 weight percent saccharin and about 70 weight percent polydimethylsiloxane. The film is then allowed to stabilize for 24 hours at room temperature, after which it is cut to yield particles of polydimethylsiloxane-encapsulated saccharin having a number average particle size of about 200 to about 800 micrometers.

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The term “combination” is inclusive of a homogenous or non-homogenous blend, mixture, or alloy of the named components into an integrated whole. The term “homogenous” refers to a uniform blend of the components.

The word “or” means “and/or.” As used herein, the term “and/or” includes any and all combinations of one or more of the associated listed items. As also used herein, the term “combinations thereof” includes combinations having at least one of the associated listed items, wherein the combination can further include additional, like non-listed items.

Reference throughout the specification to “another embodiment”, “an embodiment”, “some embodiments”, and so forth, means that a particular element (e.g., feature, structure, and/or characteristic) described in connection with the embodiment is included in at least one embodiment described herein, and can or cannot be present in other embodiments. In addition, it is to be understood that the described elements can be combined in any suitable manner in the various embodiments and are not limited to the specific combination in which they are discussed.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A chewing gum composition comprising a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient.

2. The chewing gum composition of claim 1, wherein the polydiorganosiloxane comprises repeating units having the structure 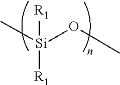
wherein each occurrence of R₁ is independently an unsubstituted or substituted C₁-C₁₂ hydrocarbyl, and wherein n equals the number of repeating units.

3. The chewing gum composition of claim 2, wherein n equals from about 700 to about 12,000 repeating units.

4. The chewing gum composition of claim 1, wherein the polydiorganosiloxane comprises a polydimethylsiloxane.

5. The chewing gum composition of claim 1, wherein the continuous phase comprises at least 50 weight percent of the polydiorganosiloxane, based on the weight of the continuous phase.

6. The chewing gum composition of claim 1, wherein the active ingredient has a water solubility of at least 100 grams per liter at 25° C. and one atmosphere.

7. The chewing gum composition of claim 1, wherein the active ingredient is selected from the group consisting of food-grade acids, flavorings, high-intensity sweeteners, oral care agents, antioxidants, nutraceuticals, pharmaceutical actives, and combinations thereof.

8. The chewing gum composition of claim 1, wherein the active ingredient comprises a food-grade acid.

9. The chewing gum composition of claim 8, wherein the food-grade acid is selected from the group consisting of adipic acid, ascorbic acid, aspartic acid, benzoic acid, citric acid, fumaric acid, glutamic acid, maleic acid, malic acid, oxalic acid, sorbic acid, succinic acid, tartaric acid, and combinations thereof.

10. The chewing gum composition of claim 1, wherein the active ingredient comprises a high intensity sweetener.

11. The chewing gum composition of claim 9, wherein the high intensity sweetener is selected from the group consisting of dihydrochalcones, monellin, Rebaudioside A, Rebaudioside B, Rebaudioside C, steviosides, glycyrrhizin, dihydroflavenol, saccharin, saccharin salts, cyclamate salts, acesulfame salts, L-aspartyl-L-phenylalanine methyl ester (Aspartame), L-alpha-aspartyl-N-(2,2,4,4-tetramethyl-3-thietanyl)-D-alaninamide hydrate (Alitame), L-alpha-aspartyl-L-phenylglycine methyl ester, L-alpha-aspartyl-L-2,5-dihydrophenylglycine methyl ester, L-alpha-aspartyl-2,5-dihydrophenylalanine methyl ester; L-aspartyl-L-(1-cyclohexen)alanine, N—(N-(3,3-dimethylbutyl)-L-alpha-aspartyl)-L-phenylalamine methyl ester (Neotame), steviosides, 1,6-dichloro-1,6-dideoxy-β-D-fructofuranosyl-4-chloro-4-deoxy-α-D-galactopyranoside (Sucralose), (2S,4S)-4-Amino-2-hydroxy-2-(1H-indol-3-ylmethyl)-pentanedioic acid (monatin), thaumatin, talin, mogrosides (Luo han Guo) and combinations thereof.

12. The chewing gum composition of claim 1, wherein the active ingredient comprises a flavoring selected from the group consisting of a powder flavor, a liquid flavor, a natural vegetable component, a flavoring aromatic, a flavoring oil, an essential oil, an essence, an extract, a food-grade acid, an oleoresin, a plant extract, a flower extract, a fruit extract, and combinations thereof.

13. The chewing gum composition of claim 12, wherein the flavoring is present in an amount of about 0.01 weight percent to about 30 weight percent of the gum composition, based upon the weight of the chewing gum composition.

14. The chewing gum composition of claim 1, wherein the chewing gum composition further comprises a gum base selected from the group consisting of smoked latex, liquid latex, guayule, jelutong, lechi caspi, perillo, sorva, massaranduba balata, massaranduba chocolate, nispero, rosidinha, crown gum, chicle, gutta percha, gutta kataiu, gutta kay, niger gutta, tunu, chilte, chiquibul, gutta hang kang, butadiene-styrene copolymers, polyisoprene, polyisobutylene, isobutylene-isoprene copolymers, polyethylene, polybutene, polybutadiene, polyisobutylene, poly(vinyl acetate), polyethylene, vinyl copolymeric elastomers, and combinations thereof.

15. The chewing gum composition of claim 14, wherein the gum base is present in an amount of about 5 weight percent to about 94 weight percent of the gum composition, based on the total weight of the chewing gum composition.

16. The chewing gum composition of claim 14, wherein the chewing gum base further comprises a softener selected from the group consisting of lanolin, palmitic acid, oleic acid, stearic acid, fatty acids, sodium stearate, potassium stearate, glyceryl triacetate, glyceryl lecithin, glyceryl monostearate, propylene glycol monostearate, monoglycerides, diglycerides, triglycerides, acetylated monoglycerides, glycerin, lecithin, diacetin, waxes, and combinations thereof.

17. The chewing gum composition of claim 16, wherein the softener is present in an amount up to about 30 weight percent, based on the total weight of the chewing gum composition.

18. The chewing gum composition of claim 1, wherein the disperse phase comprises at least 50 weight percent of the active ingredient.

19. The chewing gum composition of claim 1, further comprising a disperse phase texture modifier selected from the group consisting of butyl rubber, talc, silica, and combinations thereof.

20. The chewing gum composition of claim 1, wherein the polydiorganosiloxane-encapsulated active ingredient comprises about 50 to about 95 weight percent of the continuous phase and about 5 to about 50 weight percent of the disperse phase, based on the weight of the polydiorganosiloxane-encapsulated active ingredient.

21. The chewing gum composition of claim 1, wherein the disperse phase has a number average particle size of about 2 to about 500 micrometers.

22. The chewing gum composition of claim 1, wherein at least 75 weight percent of the disperse phase particles have a particle size of about 5 to about 200 micrometers.

23. The chewing gum composition of claim 1, wherein the disperse phase has a maximum particle size less than or equal to 500 micrometers.

24. The chewing gum composition of claim 1, wherein the polydiorganosiloxane-encapsulated active ingredient is present in the chewing gum composition in a particulate form having a number average particle size of about 50 to about 4000 micrometers.

25. The chewing gum composition of claim 1, wherein the polydiorganosiloxane-encapsulated active ingredient is present in the chewing gum composition in a particulate form, wherein the particulate form comprises at least 75 weight percent of particles having a particle size of about 75 to about 500 micrometers.

26. The chewing gum composition of claim 1, wherein the encapsulated active has a maximum particle size less than or equal to 4000 micrometers.

27. The chewing gum composition of claim 1, comprising about 1 to about 20 weight percent of the polydiorganosiloxane-encapsulated active ingredient, based on the total weight of the chewing gum composition.

28. The chewing gum composition of claim 1,
wherein the polydiorganosiloxane comprises a polydimethylsiloxane;
wherein the continuous phase comprises at least 90 weight percent of the polydiorganosiloxane, based on the weight of the continuous phase;
wherein the active ingredient comprises a food-grade acid;
wherein the disperse phase comprises at least 50 weight percent of the food-grade acid;
wherein the polydiorganosiloxane-encapsulated active ingredient comprises about 50 to about 95 weight percent of the continuous phase and about 5 to about 50 weight percent of the disperse phase, based on the weight of the polydiorganosiloxane-encapsulated active ingredient;
wherein the disperse phase has a number average particle size of about 5 to about 200 micrometers; and
wherein the polydiorganosiloxane-encapsulated active ingredient is present in the chewing gum composition in a particulate form having a number average particle size of about 75 to about 500 micrometers.

29. A chewing gum composition comprising:
an at least one first flavor composition; and
an at least one second flavor composition comprising a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient,
wherein the at least one first flavor composition begins to release from the chewing gum when the chewing gum composition is masticated, and the at least one second flavor composition begins to release after the at least one first flavor composition has begun to release.

30. The chewing gum composition of claim 29, wherein the at least one first flavor composition comprises a sweetener and the at least one second flavor composition comprises a food-grade acid.

31. The chewing gum composition of claim 29, wherein the at least one first flavor composition releases for about 5 minutes to about 7 minutes after mastication begins and the at least one second flavor composition releases for about 8 minutes to about 10 minutes after mastication begins.

32. A chewing gum composition comprising:
an at least one first flavor composition;
an at least one second flavor composition; and
an at least one third flavor composition comprising a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient,
wherein the at least one first flavor composition begins to release from the chewing gum when the chewing gum composition is masticated, the at least one second flavor composition begins to release after the at least one first flavor composition has begun to release and the at least one third flavor composition releases after the second flavor composition begins to release.

33. The chewing gum composition of claim 32, wherein the at least one second flavor composition comprises a polydiorganosiloxane-encapsulated active ingredient, wherein the polydiorganosiloxane-encapsulated active ingredient comprises a continuous phase comprising a polydiorganosiloxane and a disperse phase comprising solid particles comprising an active ingredient.

34. The chewing gum composition of claim 32, wherein the at least one first flavor composition comprises a sweetener, the at least one second flavor composition comprises a food grade acid, and the at least one third flavor composition comprises a sweetener.

35. The chewing gum composition of claim 32, wherein the at least one first flavor composition releases for about 5 minutes to about 7 minutes after mastication begins, the at least one second flavor composition releases for about 8 minutes to about 10 minutes after mastication begins, and the at least one third flavor composition releases for about 10 minutes to about 30 minutes after mastication begins.

36. A material comprising:
a continuous phase comprising a polydiorganosiloxane; and
a disperse phase comprising an active ingredient that is a solid at 25° C. and one atmosphere.

37. The material of claim 36, wherein the polydiorganosiloxane comprises repeating units having the structure 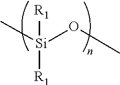
wherein each occurrence of R₁ is independently an unsubstituted or substituted C₁-C₁₂ hydrocarbyl, and wherein n equals the number of repeating units.

38. The material of claim 37, wherein n equals from about 700 to about 12,000 repeating units.

39. The material of claim 36, wherein the polydiorganosiloxane comprises a polydimethylsiloxane.

40. The material of claim 36, wherein the continuous phase comprises at least 50 weight percent of the polydiorganosiloxane, based on the weight of the continuous phase.

41. The material of claim 36, wherein the continuous phase further comprises a continuous phase texture modifier selected from the group consisting of poly(vinyl acetate), fats, and combinations thereof.

42. The material of claim 36, wherein the active ingredient has a water solubility of at least 100 grams per liter at 25° C. and one atmosphere.

43. The material of claim 36, wherein the active ingredient is selected from the group consisting of food-grade acids, flavorings, high-intensity sweeteners, oral care agents, antioxidants, nutraceuticals, pharmaceutical actives, and combinations thereof.

44. The material of claim 36, wherein the active ingredient comprises a food-grade acid.

45. The material of claim 44, wherein the food-grade acid is selected from the group consisting of adipic acid, ascorbic acid, aspartic acid, benzoic acid, citric acid, fumaric acid, glutamic acid, maleic acid, malic acid, oxalic acid, sorbic acid, succinic acid, tartaric acid, and combinations thereof.

46. The material of claim 36, wherein the active ingredient comprises a high intensity sweetener.

47. The material of claim 46, wherein the high intensity sweetener is selected from the group consisting of dihydrochalcones, monellin, Rebaudioside A, Rebaudioside B, Rebaudioside C, steviosides, glycyrrhizin, dihydroflavenol, saccharin, saccharin salts, cyclamate salts, acesulfame salts, L-aspartyl-L-phenylalanine methyl ester (Aspartame), L-alpha-aspartyl-N-(2,2,4,4-tetramethyl-3-thietanyl)-D-alaninamide hydrate (Alitame), L-alpha-aspartyl-L-phenylglycine methyl ester, L-alpha-aspartyl-L-2,5-dihydrophenylglycine methyl ester, L-alpha-aspartyl-2,5-dihydrophenylalanine methyl ester; L-aspartyl-L-(1-cyclohexen)alanine, N—(N-(3,3-dimethylbutyl)-L-alpha-aspartyl)-L-phenylalamine methyl ester (Neotame), steviosides, 1,6-dichloro-1,6-dideoxy-β-D-fructofuranosyl-4-chloro-4-deoxy-α-D-galactopyranoside (Sucralose), (2S,4S)-4-Amino-2-hydroxy-2-(1H-indol-3-ylmethyl)-pentanedioic acid (monatin), thaumatin, talin, and combinations thereof.

48. The material of claim 36, wherein the active ingredient comprises a flavoring selected from the group consisting of a powder flavor, a liquid flavor, a natural vegetable component, a flavoring aromatic, a flavoring oil, an essential oil, an essence, an extract, a food-grade acid, an oleoresin, a plant extract, a flower extract, a fruit extract, and combinations thereof.

49. The material of claim 48, wherein the flavoring is present in an amount of about 0.01 weight percent to about 30 weight percent of the gum composition, based on the total weight of the chewing gum composition.

50. The material of claim 36, wherein the disperse phase comprises at least 50 weight percent of the active ingredient.

51. The material of claim 36, further comprising a disperse phase texture modifier selected from the group consisting of butyl rubber, talc, silica, and combinations thereof.

52. The material of claim 36, wherein the polydiorganosiloxane-encapsulated active ingredient comprises about 50 to about 95 weight percent of the continuous phase and about 5 to about 50 weight percent of the disperse phase, based on the weight of the polydiorganosiloxane-encapsulated active ingredient.

53. The material of claim 36, wherein the disperse phase has a number average particle size of about 2 to about 500 micrometers.

54. The material of claim 36, wherein at least 75 weight percent of the disperse phase particles have a particle size of about 5 to about 200 micrometers.

55. The material of claim 36, wherein the disperse phase has a maximum particle size less than or equal to 500 micrometers.

56. The material of claim 36, in a particulate form having a number average particle size of about 50 to about 4000 micrometers.

57. The material of claim 36, in a particulate form comprising at least 75 weight percent of particles having a particle size of about 75 to about 500 micrometers.

58. The material of claim 36, in a particulate form having a maximum particle size of about 4000 micrometers.

59. The material of claim 36,
wherein the polydiorganosiloxane comprises a polydimethylsiloxane;
wherein the continuous phase comprises at least 90 weight percent of the polydiorganosiloxane, based on the weight of the continuous phase;
wherein the active ingredient comprises a food-grade acid;
wherein the disperse phase comprises at least 50 weight percent of the food-grade acid;
wherein the material comprises about 50 to about 95 weight percent of the continuous phase and about 5 to about 50 weight percent of the disperse phase, based on the weight of the material; and
wherein the disperse phase has a number average particle size of about 2 to about 500 micrometers.

60. A method of forming a polydiorganosiloxane-encapsulated active, comprising:
dispersing solid particles comprising an active ingredient in a curable polydiorganosiloxane composition; and
curing the curable polydiorganosiloxane composition to form a polydiorganosiloxane-encapsulated active ingredient comprising
a continuous phase comprising a polydiorganosiloxane, and
a disperse phase comprising solid particles comprising the active ingredient.

61. The method of claim 60, wherein said curing comprises catalyzing a hydrosilylation reaction in the curable composition.

62. The method of claim 60, wherein said curing comprises catalyzing a vinyl polymerization reaction in the curable composition.

63. The method of claim 60, wherein said curing comprises catalyzing a condensation reaction in the curable composition.

64. The method of claim 60, further comprising dispersing a texture modifier in the curable composition; wherein the texture modifier is selected from the group consisting of poly(vinyl acetate), fats, butyl rubber, talc, silica, and combinations thereof.

65. The method of claim 60, further comprising dividing the polydiorganosiloxane-encapsulated active ingredient into particles having a number average particle size of about 50 to about 4000 micrometers.

66. A chewing gum composition made by the method of claim 60.

67. A method of forming a chewing gum, comprising:
(a) forming a polydiorganosiloxane-encapsulated active, comprising:
i. dispersing solid particles comprising an active ingredient in a curable polydiorganosiloxane composition;
ii. curing the curable polydiorganosiloxane composition to form the polydiorganosiloxane-encapsulated active ingredient comprising a continuous phase comprising a polydiorganosiloxane, and a disperse phase comprising solid particles comprising the active ingredient; and
iii. processing the polydiorganosiloxane-encapsulated active into a particulate form; and
(b) dispersing the particulate form of the polydiorganosiloxane-encapsulated active into a gum base.

68. The method of claim 67, further comprising extruding the solid particles comprising an active ingredient and the polydiorganosiloxane composition into a film.

69. The method of claim 68, further comprising cooling the cured film of the polydiorganosiloxane-encapsulated active ingredient.

70. A chewing gum composition made by the method of claim 67.
